(19) United States
(12) Patent Application Publication
(10) Pub. No.: US 2009/0084895 A1
(43) Pub. Date: Apr. 2, 2009

(54) Aircraft Skid Shoes with Wear-Resistant Cladding Layers

(75) Inventor: Charles Hunter Holwerk, New Albany, IN (US)

Correspondence Address: KENNAMETAL INC.;Intellectual Property Department, P.O. BOX 231, 1600 TECHNOLOGY WAY, LATROBE, PA, 15650, US

(73) Assignee: Kennametal Inc., Latrobe, PA (US)

(21) Appl. No.: 11/863,398

(22) Filed: Sep. 28, 2007

(51) Int. Cl. B64C 25/52

(52) U.S. Cl. 244/108

(57) ABSTRACT

Aircraft skid shoes are provided with wear-resistant cladding layers. Powders of hard particles and braze material are impregnated into at least one cloth which is applied to the wear surface of a skid shoe of a helicopter or other aircraft. The skid shoe and cloth are heated to a brazing temperature to metallurgically bond the hard particles together and to the skid shoe substrate. The resultant cladding layers provide significantly increased abrasion resistance and reduced unit weight in comparison with skid shoes having conventional wear-resistant materials.

### FIELD OF THE INVENTION

The present invention relates to aircraft skid shoes, and more particularly relates to wear-resistant cladding layers for helicopter and other aircraft skid shoes.

### BACKGROUND INFORMATION

Helicopter landing gear typically comprise a pair of elongated tubular skids fastened to a helicopter fuselage by struts. During operation, the skids are subjected to wear and damage, particularly during landing. Wear-resistant skid shoes have been developed to protect helicopter skids. For example, weld beads of relatively hard material have been welded to the bottom surfaces of steel shoe pads.

U.S. Pat. No. 4,544,116 to Shwayder discloses a steel shoe pad having a downward-facing narrow channel filled with a composite material comprising hard metal carbide particles embedded in a copper brazing alloy. Composites comprising such copper-based brazing alloys have been found to suffer from relatively low abrasion resistance.

U.S. Pat. Nos. 5,893,532 and 6,000,117 to Bain disclose helicopter skid shoes including a wear-resistant surface comprising an array of cemented tungsten carbide tiles adhered to a steel shoe pad. Such tile arrays suffer from several disadvantages, including excessive weight, high cost, and time-consuming installation and repair. Tiled skid shoes are also subject to failure by cracking due to the brittle nature of the carbide tiles.

It would be desirable to provide wear-resistant skid shoes for helicopters and other aircraft with improved wear resistance.

It would also be desirable to provide wear-resistant skid shoes for helicopters and other aircraft that are light weight.

It would further be desirable to provide wear-resistant skid shoes for helicopters and other aircraft that are relatively easy to manufacture and repair.

It would also be desirable to provide a method which produces highly effective wear-resistant skid shoes for helicopters and other aircraft.

### SUMMARY OF THE INVENTION

An aspect of the present invention is to provide an aircraft skid shoe comprising a skid shoe body structured and arranged for mounting on an aircraft skid, and a wear-resistant cladding layer brazed on at least a portion of a lower surface of the skid shoe body comprising hard particles and a brazing material, wherein the cladding layer has a wear resistance of at least 50 ARF (1000/cc vol loss) points in the ASTM G65 Procedure A abrasion test.

Another aspect of the present invention is to provide an aircraft skid shoe comprising a skid shoe body structured and arranged for mounting on an aircraft skid, and a wear-resistant cladding layer brazed on at least a portion of a lower surface of the skid shoe body comprising hard particles and a nickel-based brazing material.

These and other aspects of the present invention will be more apparent from the following description.

### BRIEF DESCRIPTION OF THE DRAWINGS

FIG. 1 is a partially schematic side view of a helicopter equipped with skid shoes having wear-resistant cladding layers in accordance with an embodiment of the present invention.

FIG. 2 is a perspective view of a helicopter skid pad with a wear-resistant cladding layer in accordance with an embodiment of the invention.

FIGS. 3a and 3b are photographs of the end and bottom of a helicopter skid pad with a wear-resistant cladding layer in accordance with an embodiment of the invention.

FIGS. 4a and 4b are photographs of the end and bottom of a helicopter skid pad with a wear-resistant cladding layer in accordance with an embodiment of the invention.

### DETAILED DESCRIPTION OF PREFERRED EMBODIMENT

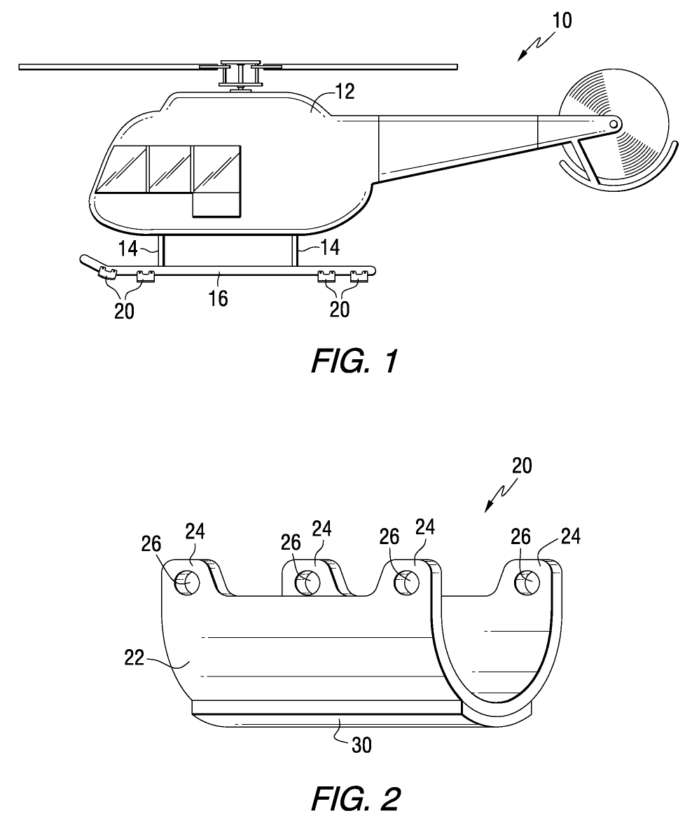

FIG. 1 is a partially schematic side view of a helicopter 10 including a fuselage 12 with struts 14 connected to skids 16. Skid shoes 20 are mounted at selected locations on the bottom of each skid 16. Although helicopter skid shoes are primarily described herein, it is to be understood that skid shoes for other types of aircraft having landing skids or skis are also within the scope of the invention. Examples of other types of aircraft include aircraft quipped for snow or ice landings, aircraft equipped for water landings and other aircraft utilizing a hard or nonrotating surface as their landing gear. In accordance with the present invention, each skid shoe 20 has a wear-resistant cladding layer, as more fully described below.

FIG. 2 illustrates a skid shoe 20 including a generally curved body 22 made of metal such as steel, stainless steel or a super alloy. Mounting tabs 24 extend upwardly at the comers of the skid shoe 20, and include holes 26 which receive mechanical fasteners (not shown) for attachment to the skid 16. Alternatively, the skid shoe 20 may be welded to the skid 16. In accordance with the present invention, a wear-resistant cladding layer 30 is secured to the bottom surface of the skid shoe body 22. The wear-resistant cladding layer 30 has a thickness T typically less than 0.25 inch, for example, from about 0.01 to about 0.18 inch.

The cladding layer 30 comprises hard particles and braze material that are applied to the skid shoe body 22 utilizing a flexible cloth. In one embodiment, the hard particles and braze material are applied together in the same flexible cloth. In another embodiment, alternating layers of cloth separately containing either the hard particles or the braze alloy are used. The skid shoe body with the layer(s) of cloth containing the hard particles and braze material is placed in an inert or reducing atmosphere furnace and then heated to a brazing temperature of the braze alloy, i.e., above the solidus temperature of the braze material. The braze alloy infiltrates into the hard particles and brazes them to each other and to the skid shoe body 22.

The hard particles may comprise cemented carbides, nitrides, borides and/or carbonitrides. One preferred example of a suitable hard particle is cobalt cemented tungsten carbide particles. For example, these particles comprise between about 5 weight percent and about 11 weight percent cobalt and between about 89 weight percent and about 95 weight percent tungsten carbide. The cemented tungsten carbide particles have a size that typically ranges between about 2 micrometers and about 500 micrometers. Other examples of suitable cemented hard particles, in addition to cemented tungsten carbide, include one or more of cemented vanadium carbide, cemented niobium carbide, cemented chromium carbide, cemented titanium carbide, cemented tantalum carbide, cemented molybdenum carbide, cemented hafnium carbide, cemented silicon carbide and cemented boron carbide. Cemented oxides such as aluminum oxide, zirconium oxide and hafnium oxide may also be used as the hard particles.

The braze material preferably comprises a nickel-based alloy with alloying additions of chromium, boron, silicon, tungsten, titanium, molybdenum, iron and/or cobalt. As used herein, the term “nickel-based” means an alloy comprising at least 50 weight percent nickel. In one embodiment, the nickel-based braze material comprises from 5 to 20 weight percent Cr, from 2 to 5 weight percent B, and the balance Ni. A typical nickel-based braze material is a nickel-chromium-boron braze alloy having the following composition: 15.5 weight percent Cr; 4.0 weight percent B; and the remainder Ni.

The cladding material may further include organic binders such as polymeric agents. A preferred binder is polytetraflouroethylene that is sold by Dupont under the name Teflon.

The cloth impregnated with the hard particles may be rolled to a predetermined thickness, forming a flexible cloth that maintains a uniform weight and readily conforms to the shape of the skid shoes. The cloth is then cut to shape and applied to a skid shoe, e.g., with a low temperature adhesive such as described in U.S. Pat. No. 4,194,040. Another cloth containing the braze material powder is then applied onto the layer of hard particle cloth. After the impregnated cloth layers are applied on the skid shoe substrate, they are heated to a temperature above the solidus of the braze material to effect the metallurgical bonding of the hard particles together and to the skid shoe substrate. The molten braze alloy capilates down into the layer of hard particles, metallurgically bonding the hard particles to each other and to the skid shoe and forming the wear-resistant cladding. The heating step bonds the cloth layer(s) into a wear-resistant coating on the skid shoe substrate.

In another embodiment of the invention, a single flexible cloth is made with a mixture of the hard particles and braze material and then applied to the skid shoe. Heating to a brazing temperature of the braze material, as described above, results in brazing of the hard particles together and to the skid shoe.

The brazing temperatures can vary depending upon the properties of the braze material, but exemplary temperatures range between a lower limit of about 550° C. and an upper limit of about 1,230° C. It should also be appreciated that the heating process to effect the metallurgical bonding may include multiple steps.

The wear-resistant helicopter skid shoe cladding layers of the present invention have been found to possess very high abrasion resistance. For example, abrasion resistance is typically above 50 ARF in accordance with the ASTM G65 Procedure A abrasion test, and may range from 60 to 120 ARF, or higher.

The wear-resistant helicopter skid shoe cladding layers provide reduced skid shoe unit weight per unit of wear resistance in comparison with conventional wear-resistant skid shoes. For example, a skid shoe made of 1018 steel with a 0.060 inch thick layer of the present cladding material may have a wear resistance per unit mass of 0.12 (g/arf), while conventional skid shoes with wear-resistant weld overlay may have wear resistance per unit mass of 0.216 (g/arf) or higher. The unit weight of each skid shoe may thus be reduced significantly in comparison with similar skid shoes having conventional types of wear-resistant materials, e.g., by at least 45 percent, while maintaining or increasing the wear-resistance of the skid shoe.

The following examples are intended to illustrate various aspects of the invention, and are not intended to limit the scope of the invention.

### EXAMPLE 1

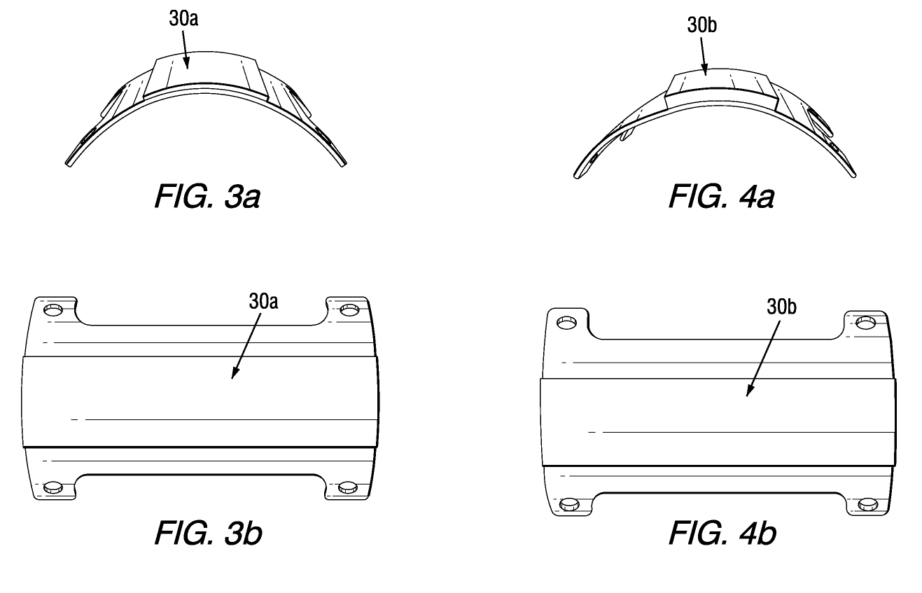

Carbide and braze cloth were rolled to a thickness of 0.030 inch and applied to an otherwise unprotected commercially available skid shoe, followed by infiltration brazing in a manner consistent with U.S. Pat. No. 4,194,040. FIGS. 3a and 3b are photographs of the resultant helicopter skid shoe.

### EXAMPLE 2

Example 1 was repeated, except the wear-resistant cladding had a thickness of 0.12 inch. FIGS. 4a and 4b are photographs of the resultant helicopter skid shoe.

### EXAMPLE 3

A comparative example was performed in which the nickel-based brazing alloy of Examples 1 and 2 was replaced with pure copper brazing alloy. The resultant skid shoe has a density within 5 percent of the nickel alloy braze skid shoe.

Abrasion resistance testing was performed on the cladding layer samples of Examples 1-3 using ASTM G65 procedure A. In testing, the Cu infiltrated WC of Example 3 has an abrasion resistance of 16 ARF. Typical abrasion resistances of the Ni—Cr—B infiltrated WC produced in accordance with Examples 1 and 2 are 80-160 ARF, depending on coating composition. The cladding layers of the present invention produced in accordance with Examples 1 and 2 possess at least about 5 times more abrasion resistance than the coating produced in accordance with Example 3.

Whereas particular embodiments of this invention have been described above for purposes of illustration, it will be evident to those skilled in the art that numerous variations of the details of the present invention may be made without departing from the invention as defined in the appended claims.

1. An aircraft skid shoe comprising:
a skid shoe body structured and arranged for mounting on an aircraft skid; and
a wear-resistant cladding layer brazed on at least a portion of a lower surface of the skid shoe body comprising hard particles and a brazing material, wherein the cladding layer has a wear resistance of at least 50 ARF.

2. The aircraft skid shoe of claim 1, wherein the brazing material comprises a nickel-based brazing alloy.

3. The aircraft skid shoe of claim 2, wherein the nickel-based brazing alloy comprises from about 5 to about 20 weight percent Cr, from about 2 to about 5 weight percent B, and the balance Ni and incidental impurities.

4. The aircraft skid shoe of claim 1, wherein the helicopter skid shoe has a density of less than 12 g/cc.

5. The aircraft skid shoe of claim 1, wherein the wear-resistant cladding layer has a thickness of less than 0.2 inch.

6. The aircraft skid shoe of claim 1, wherein the hard particles comprise a cemented carbide.

7. The aircraft skid shoe of claim 1, wherein the hard particles comprise cobalt cemented tungsten carbide.

8. The aircraft skid shoe of claim 1, wherein the aircraft is a helicopter.

9. The aircraft skid shoe of claim 1, wherein the skid shoe has a wear resistance per unit mass less than 0.15 g/arf.

10. A helicopter skid shoe comprising:
a skid shoe body structured and arranged for mounting on a helicopter skid; and
a wear-resistant cladding layer brazed on at least a portion of a lower surface of the skid shoe body comprising hard particles and a nickel-based brazing material.

11. The helicopter skid shoe of claim 10, wherein the cladding layer has a wear resistance of at least 50 ARF.

12. The helicopter skid shoe of claim 10, wherein the nickel-based brazing alloy comprises from about 5 to about 20 weight percent Cr, from about 2 to about 5 weight percent B, and the balance Ni and incidental impurities.

13. The helicopter skid shoe of claim 10, wherein the wear-resistant cladding layer has a thickness of less than 0.2 inch.

14. The helicopter skid shoe of claim 10, wherein the hard particles comprise a cemented carbide.

15. The helicopter skid shoe of claim 10, wherein the hard particles comprise cobalt cemented tungsten carbide.

16. The helicopter skid shoe of claim 10, wherein the skid shoe has a wear resistance per unit mass less than 0.15 g/arf.
